(19) United States
(12) Patent Application Publication
(10) Pub. No.: US 2010/0089873 A1
(43) Pub. Date: Apr. 15, 2010

(54) ENHANCED METAL WICKING SURFACE

(76) Inventors: Joseph M. Fridy, Pittsburgh, PA (US); Rabindra K. Bhattacharyya, Export, PA (US); Phillip A. Hollinshead, Harrison City, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/250,776

(22) Filed: Oct. 14, 2008

(51) Int. Cl. B44C 1/22

(52) U.S. Cl. 216/108

(57) ABSTRACT

A method of producing a metal structure with a grooved wicking surface is provided. An aluminum alloy is provided that is thermomechanically processed to produce grain size and shape suitable for wicking. Then, the alloy is heat treated to produce a continuous etchable phase on the grain boundaries. The alloy is then etched with a solvent that dissolves the continuous etchable phase on the grain boundaries to produce the metal structure with a grooved wicking surface. In addition, the method of producing a laminate metal structure with a grooved wicking surface is provided. The laminate is provided with at least a top layer and a bottom layer where the top layer and bottom layer are made of an aluminum alloy. The laminate is thermomechanically processed to produce grain size and shape spanning the entire depth of the top layer suitable for wicking. Then, the laminate is heat treated to produce a continuous etchable phase on the grain boundaries within the top layer. The laminate is then etched with a solvent that dissolves the continuous etchable phase on the grain boundaries of the top layer to produce the metal structure with a grooved wicking surface where the grooves have a depth equal to the thickness of the top layer where the bottom layer is substantially free of the etchable phase on the grain boundaries.

### BACKGROUND OF THE INVENTION

In one embodiment, the present invention relates to a method for producing a metal structure with a grooved wicking surface.

A wicking surface is a material surface which has been treated to wick fluid via capillary action.

In one embodiment, the present invention discloses a method for producing a grooved wicking metal structure.

### SUMMARY OF THE INVENTION

In one embodiment, the present invention provides a method for producing a metal structure including the steps of providing an aluminum alloy, thermomechanically processing the alloy to produce grain size and shape suitable for wicking, heat treating the alloy to produce a continuous etchable phase on the grain boundaries, and etching the alloy with a solvent that dissolves the continuous etchable phase on the grain boundaries to produce the metal structure with a grooved wicking surface.

In one embodiment, the continuous etchable phase is magnesium bearing. In another embodiment, the solvent is nitric acid. In a further embodiment, the etching step is from about 5 minutes to about 90 minutes at a temperature range about 30° C. to about 90° C.

In one embodiment, the grain size of the aluminum alloy is from about 10 microns to about 500 microns.

In one embodiment, the present invention discloses a method of producing a metal structure including the steps of providing a laminate having at least a top layer and a bottom layer where the top layer and the bottom layer are made of an aluminum alloy, thermomechanically processing the laminate to produce grain size and shape spanning the entire depth of the top layer suitable for wicking, heat treating the laminate to produce a continuous etchable phase on the grain boundaries within the top layer, and etching the laminate with a solvent that dissolves the continuous etchable phase on the grain boundaries of the top layer to produce the metal structure with a grooved wicking surface where the grooves have a depth equal to the thickness of the top layer. Here, the bottom layer is substantially free of the etchable phase on the grain boundaries.

In one embodiment, the continuous etchable phase is magnesium bearing. In another embodiment, solvent is nitric acid. In a further embodiment, the etching step is from about 5 minutes to about 90 minutes at a temperature range about 30° C. to about 90° C.

In one embodiment, the grain size of the aluminum alloy is from about 10 microns to about 500 microns.

In one embodiment, further comprising stretching the metal structure to change the width of the grooves.

In one embodiment, further comprising straining the continuous etchable phase on the grain boundaries to deform the grain boundaries in the direction of the strain before the etching step. In another embodiment, the straining step is accomplished by rolling.

In one embodiment, the resulting groove structure of the present invention has a plurality of grooves that are sharp.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

For a fuller understanding of the invention, reference is made to the following description taken in connection with the accompanying drawing(s), in which:

FIG. 1 is a flow chart showing one embodiment of the method of producing metal structure with a grooved wicking surface in accordance with the present invention;

FIG. 2 is a flow chart showing another embodiment of the method of producing metal laminate structure with a grooved wicking surface in accordance with the present invention;

FIG. 3 is a scanning electron microscope photomicrograph at 1000 times magnification of the grooved wicking surface of a metal structure in accordance with one embodiment of the invention;

FIG. 4 is a schematic side view drawing depicting a two layer aluminum alloy laminate after thermomechanically processing and heat treating the laminate but before etching the laminate in accordance with one embodiment of the invention;

FIG. 5 is a schematic side view drawing depicting the two layer aluminum alloy laminate after etching the laminate in accordance with one embodiment of this invention; and

FIG. 6 is a schematic side view drawing depicting the two layer aluminum alloy laminate after etching and post stretching the laminate in accordance with one embodiment of this invention.

### DETAILED DESCRIPTION OF THE PREFERRED EMBODIMENTS

In one embodiment, the present invention discloses a method for producing a grooved wicking metal structure where the grain size of the system is controlled through thermomechanical processing and the cell size and morphology of the network of grooves is controllable by virtue of controlling the grain size. In another embodiment, the depth and shape of the groove network is controllable by controlling the concentration and temperature of the solvent, and the etching time. In a further embodiment, the morphology of the resulting network can be further changed by stretching the surface after the etching step has been completed. In still a further embodiment, the maximum depth of the grooves can be enhanced by bonding a sheet of the alloy to a substrate deficient in the etchable component. In one embodiment, this bonding can be achieved by lamination. By manipulating the grain size and etching practice in the etchable layer, groove depths is the full thickness of the etchable layer can be achieved without destroying the integrity of the product in accordance with one embodiment of the invention.

The followings are the definitions of the terms used in this application. As used herein, the term “thermomechanically processing” means the deformation or heat treatment of a metal with the intent to change the properties or microstructure of the metal.

As used herein, the term “grain size” means the size of an individual crystal within the metal.

As used herein, the term “grain shape” means the mean shape of an individual crystal within the metal.

As used herein, the term “wicking” means the transport of a fluid through capillary action.

As used herein, the term “grain boundaries” means those regions within the metal where two or more grains abut.

As used herein, the term “continuous etchable phase” means a phase which is susceptible to be etchable by a chemical agent and not into disjoint regions.

As used herein, the term “metal laminate” means a structure that consists of a least two sheets of metal which are bound together by whatever means.

In one embodiment, the present invention discloses a method for producing a metal structure including the steps of providing an aluminum alloy, thermomechanically processing the alloy to produce grain size and shape suitable for wicking, heat treating the alloy to produce a continuous etchable phase on the grain boundaries, and etching the alloy with a solvent that dissolves the continuous etchable phase on the grain boundaries to produce the metal structure with a grooved wicking surface.

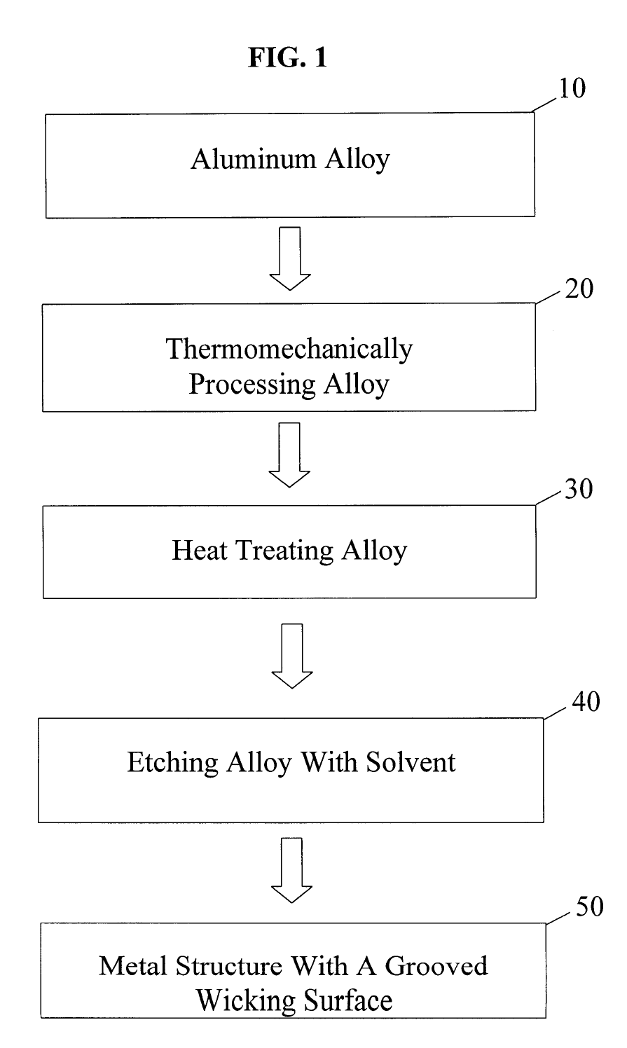

FIG. 1 shows a flow chart outlining the principal steps of one embodiment of the present invention. Here, an aluminum alloy is provided in the first step 10. In the second step 20, the aluminum alloy is thermomechanically processed. In the third step 30, the aluminum alloy is heat treated to produce a continuous etchable phase on the grain boundaries. The aluminum alloy is then etched with a solvent that dissolves the continuous etchable phase on the grain boundaries in the fourth step 40 to produce the aluminum alloy metal structure with a grooved wicking surface in the last step 50.

In the initial step, an aluminum alloy is provided. Suitable types of aluminum alloys that may be used in the present invention include, but are not limited to, aluminum magnesium alloy having about 2.5% to about 12% of magnesium.

In the second step, the aluminum alloy is thermomechanically processed by either deformation or heat treatment of a metal with the intent to change the properties or microstructure of the metal to produce grain size and shape suitable for wicking. Suitable types of ways to mechanically process the aluminum alloys that may be used in the present invention include, but are not limited to, hot rolling, cold rolling, extrusion, or forging. Suitable types of ways to thermally process the aluminum alloys that may be used in the present invention include, but are not limited to annealing, recrystallization, or recovery. In one embodiment, the aluminum alloy is heat treated for about 10 seconds to about 3 hours at a temperature range about 280° C. to about 480° C. In another embodiment, the grain size of the aluminum alloy is from about 10 microns to about 500 microns.

In the third step, the aluminum alloy is heat treated to produce a continuous etchable phase on the grain boundaries. In one embodiment, the aluminum alloy is heated at about 10 hours to about 10 days at a temperature range about 120° C. to about 180° C.

In the fourth step, the aluminum alloy is etched with a solvent that dissolves the continuous etchable phase on the grain boundaries to produce the metal structure with a grooved wicking surface. In one embodiment, the solvent used is nitric acid in a concentration of about 20% to about 70%. In another embodiment, the etching step is from about 5 minutes to about 90 minutes at a temperature range of about 30° C. to about 90° C. In another embodiment, the etching step is at a temperature of about 70° C. to about 80° C.

Suitable types of solvents that may be used in the present invention include, but are not limited to, nitric acid or caustic NaOH. In one embodiment, the solvent used depends on the type of continuous etchable phase on the aluminum alloy.

Optionally, the continuous etchable phase on the grain boundaries may be strained to deform the grain boundaries in the direction of the strain before the etching step. In one embodiment, the straining may be done by rolling.

In another embodiment, the present invention discloses a method of producing a metal structure comprising the steps of providing a laminate having at least a top layer and a bottom layer where both layers are made of an aluminum alloy, thermomechanically processing the laminate to produce grain size and shape spanning the entire depth of the top layer suitable for wicking, heat treating the laminate to produce a continuous etchable phase on the grain boundaries within the top layer, etching the laminate with a solvent that dissolves the continuous etchable phase on the grain boundaries of the top layer, and producing the metal structure with a grooved wicking surface where the grooves have a depth equal to the thickness of the top layer where the bottom layer is substantially free of the etchable phase on the grain boundaries.

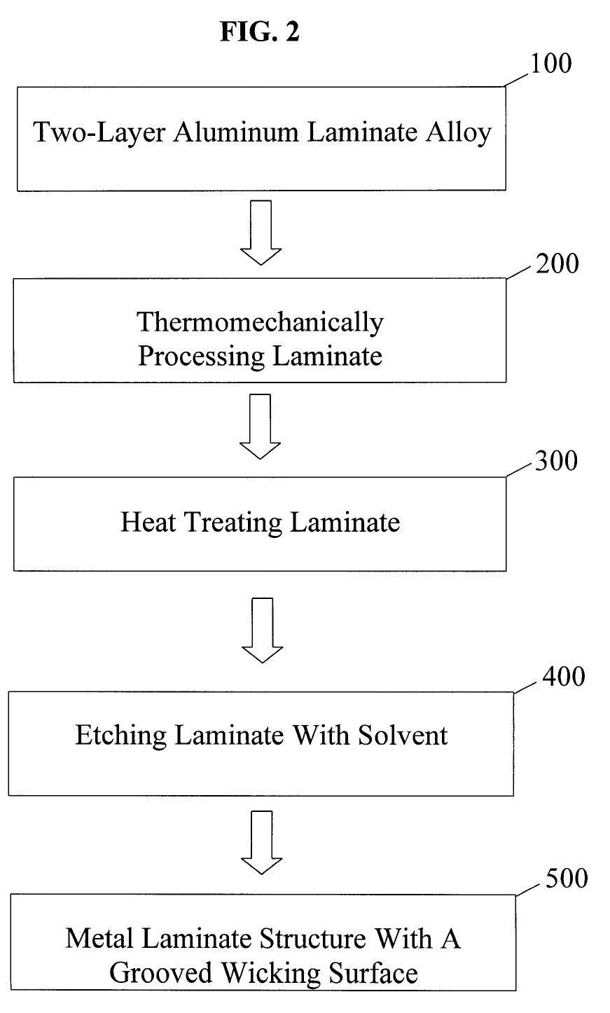

In one embodiment, FIG. 2 shows a flow chart outlining the principal steps of the present invention. Here, a laminate having at least a top layer and a bottom layer where the top layer and the bottom layer are made of an aluminum alloy is provided in the first step 100. In the second step 200, the laminate is thermomechanically processed to produce grain size and shape spanning the entire depth of the top layer suitable for wicking. In the third step 300, the laminate is heat treated to produce a continuous etchable phase on the grain boundaries within the top layer. The laminate is then etched with a solvent that dissolves the continuous etchable phase on the grain boundaries of the top layer in the fourth step 400 to produce the aluminum alloy laminate metal structure with a grooved wicking surface where the grooves have a depth equal to the thickness of the top layer in the last step 500. Thus, the bottom layer is substantially free of the etchable phase on the grain boundaries.

In the initial step, an aluminum laminate alloy is provided that has at least a top layer and a bottom layer. However, the bottom layer is substantially fee of the etchable phase on the grain boundaries. Suitable types of aluminum laminates alloys that may be used in the present invention include, but are not limited to, aluminum magnesium alloy having about 2.5% to about 12% of magnesium for the top layer and an aluminum alloy with no magnesium or less than 2.5% of magnesium for the bottom layer.

In the second step, the aluminum laminate alloy is thermomechanically processed by either deformation or heat treatment of a metal with the intent to change the properties or microstructure of the top layer of the metal to produce grain size and shape spanning the entire depth of the top layer suitable for wicking. Suitable types of ways to mechanically process the aluminum alloys that may be used in the present invention include, but are not limited to, hot rolling, cold rolling, extrusion, or forging. Suitable types of ways to thermally process the aluminum alloys that may be used in the present invention include, but are not limited to annealing, recrystallization, or recovery. In one embodiment, the aluminum alloy is heat treated for about 10 seconds to about 3 hours at a temperature range about 280° C. to about 480° C. In another embodiment, the grain size of the aluminum alloy is from about 10 microns to about 500 microns.

In the third step, the aluminum laminate alloy is heat treated to produce a continuous etchable phase on the grain boundaries within the top layer. In one embodiment, the aluminum alloy is heated at about 10 hours to 10 days at a temperature range about 120° C. to about 180° C.

In the fourth step, the aluminum laminate alloy is etched with a solvent that dissolves the continuous etchable phase on the grain boundaries of the top layer to produce the metal structure with a grooved wicking surface where the groove have a depth equal to the thickness of the top layer. In addition, the bottom layer is substantially free of the etchable phase on the grain boundaries. In another embodiment, the etching step is from about 5 minutes to about 90 minutes at a temperature range of about 30° C. to about 90° C. In another embodiment, the etching step is at a temperature of about 70° C. to about 80° C.

Suitable types of solvents that may be used in the present invention include, but are not limited to, nitric acid, or caustic (NaOH). In one embodiment, the solvent used depends on the type of continuous etchable phase on the aluminum alloy.

Optionally, the continuous etchable phase on the grain boundaries may be strained to deform the grain boundaries in the direction of the strain before the etching step. In one embodiment, the straining may be done by rolling.

Also, the metal laminate structure may be optionally stretched in order to change the width of the grooves.

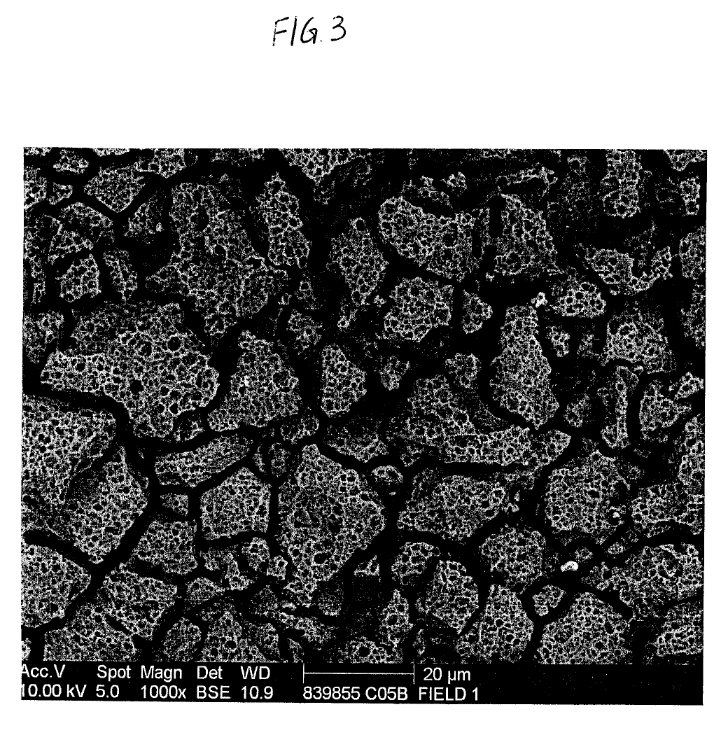

FIG. 3 shows a scanning electron microscope photomicrograph at 1000 times magnification of the grooved wicking surface of a metal structure in accordance with one embodiment of the invention. The dark boundaries were once filled with a continuous etchable component and are now sharp grooves. Note that the grooves make a connected network, making the wicking of the fluid over long distances possible. The grooves also follow the grain morphology, making it possible to control the characteristics of the network by controlling the size and shape of the grains.

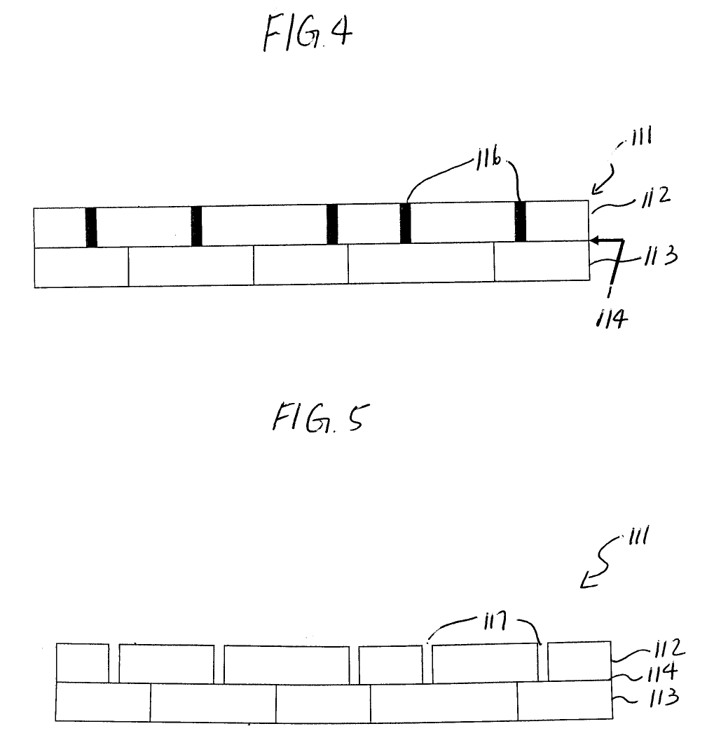

FIG. 4 shows a two layer aluminum alloy laminate 111 having a top layer 112 and a bottom layer 113 that are either metallurgically bonded or adhesively bonded 114. Note that top layer 112 contains a continuous etchable phase 116 on the grain boundaries spanning the entire depth of top layer 112. This results after thermomechanically processing and heat treating the laminate but before etching step.

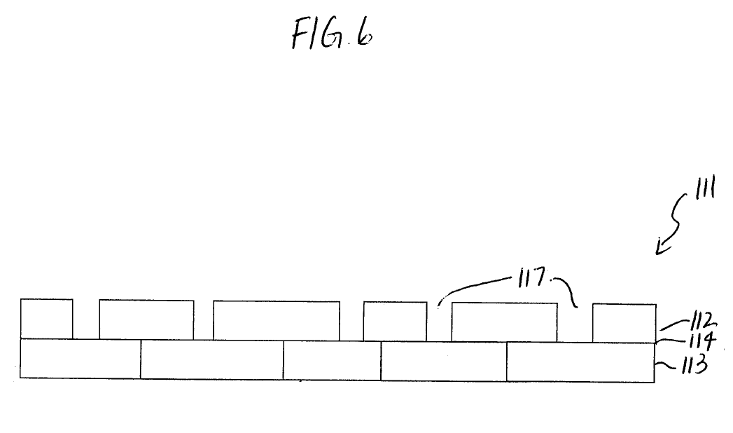

FIG. 5 shows a two layer aluminum alloy laminate 111 where the continuous etchable phase 116 is etched out by the solvent to produce grooves 117. This results after etching laminate 111.

FIG. 6 shows two layer aluminum alloy laminate 111 after etching and post stretching the laminate to increase the width of the grooves 117.

### Example

Hot roll an Al-5% Mg-0.07% Mn alloy to 2.5 mm thick. Anneal the resulting sheet at 371° C. for 2 hours, to build the desired grain structure. Hold the annealed sheet at 163° C. for 168 hours, to move the Mg to the grain boundaries. Etch the sheet with 50% HNO₃ at 70° C. for 7 minutes. The resulting wicking surface is depicted in FIG. 3.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of producing a metal structure comprising the steps of:
providing an aluminum alloy;
thermomechanically processing the alloy to produce grain size and shape suitable for wicking;
heat treating the alloy to produce a continuous etchable phase on the grain boundaries;
etching the alloy with a solvent that dissolves the continuous etchable phase on the grain boundaries; and
producing the metal structure with a grooved wicking surface.

2. The method of claim 1, wherein the continuous etchable phase is magnesium bearing.

3. The method of claim 2, wherein the solvent is nitric acid.

4. The method of claim 3, wherein the etching step is from about 5 minutes to about 90 minutes at a temperature range of about 30° C. to about 90° C.

5. The method of claim 1, wherein the grain size is from about 10 microns to about 500 microns.

6. The method of claim 1, further comprising the step of straining the continuous etchable phase on the grain boundaries to deform the grain boundaries in the direction of the strain before the etching step.

7. The method of claim 6, wherein straining step is accomplished by rolling.

8. A method of producing a metal structure comprising the steps of:
providing a laminate having at least a top layer and a bottom layer,
wherein the top layer is an aluminum alloy;
wherein the bottom layer is an aluminum alloy;
thermomechanically processing the laminate to produce grain size and shape spanning the entire depth of the top layer suitable for wicking;
heat treating the laminate to produce a continuous etchable phase on the grain boundaries within the top layer;
etching the laminate with a solvent that dissolves the continuous etchable phase on the grain boundaries of the top layer; and
producing the metal structure with a grooved wicking surface where the grooves have a depth equal to the thickness of the top layer,
wherein the bottom layer is substantially free of the etchable phase on the grain boundaries.

9. The method of claim 8, wherein the continuous etchable phase is magnesium bearing.

10. The method of claim 9, wherein the solvent is nitric acid.

11. The method of claim 8, wherein the etching step is from about 5 minutes to about 90 minutes at a temperature range of about 30° C. to about 90° C.

12. The method of claim 8, wherein the grain size is from about 10 microns to about 500 microns.

13. The method of claim 8, further comprising stretching the metal structure to change the width of the grooves.

14. The method of claim 8, further comprising the step of straining the continuous etchable phase on the grain boundaries to deform the grain boundaries in the direction of the strain before the etching step.

15. The method of claim 14, wherein straining step is accomplished by rolling.
